(19) United States
(12) Patent Application Publication
(10) Pub. No.: US 2012/0121883 A1
(43) Pub. Date: May 17, 2012

(54) Gypsum Board for Generating Negative Ions and Far Infrared Radiation and Method of Producing Thereof

(76) Inventor: Bee Haa Tee, Selangor Darul Ehsan (MY)

(21) Appl. No.: 13/387,040

(22) PCT Filed: Aug. 3, 2010
(86) PCT No.: PCT/MY10/00136

§ 371 Date: Jan. 25, 2012

(30) Foreign Application Priority Data
Aug. 3, 2009 (MY) PI 20093209

(51) Int. Cl. B32B 5/16; C09K 11/00

(52) U.S. Cl. 428/292.1; 264/21

(57) ABSTRACT

The present invention provides a gypsum board for generating negative ions and far-infrared radiation and method of producing the board whereby the invention aims to provide a healthy living environment. The gypsum board for generating negative ions and far-infrared radiation comprises of three layers wherein the surface panel (50) containing pulverized mineral powder, gypsum powder and water that have the ability of generating negative ions and far-infrared radiation naturally, the layer of fiber glass (51) sandwiched between the surface panel (50) and the base (52) containing fiber glass means to reinforce the gypsum board and the base (52) containing gypsum powder and water means for covering the layer of fiber glass (51). The method of producing the gypsum board involves forming the three layers one after another, followed by settling and curing in a mold. The negative ions and far-infrared radiation emitted continuously from the gypsum board is capable to remove airborne contaminants from the air, eliminate unpleasant odors and thus providing a healthy living environment.

### TECHNICAL FIELD

The present invention relates to a gypsum board and, more particularly, to a gypsum board for generating negative ions and far infrared rays that assist in providing a healthy living environment and method of producing thereof.

### BACKGROUND ART

As technology advances, scientists have discovered the existence of positively charged ions in the ambient atmosphere of confined buildings including office buildings and other indoor area and suggested a need to neutralize the concentration of positive ions and promote higher concentration of negative ions in order to provide a healthy living environment for human beings. The negative ions can provide a clean and particle-free environment because they are known to remove airborne contaminants such as dust particles, pollens and other harmful particles by colliding themselves with the particles and causing the particles to drop from the air due to their heavy weight.

Numerous commercialized inventions that generate negative ions are available in the market such as the ionizers incorporated into household products. They are able to eliminate irritating odors by breaking down the excessive molecules that could reach the threshold of human sensation. Such ionizers are operated using electrical supply and rely on multiples of pointed electrodes to discharge negative ions.

Other than negative ions, a long wavelength radiation, namely the far, infrared radiation are commonly used in heat therapy as the said radiation can penetrate body's tissues to a depth of 1.5 to 3 inches. The far infrared radiation can effectively helps in blood circulation through the heating effect. The radiation can also remove toxic from human body when the frequency of the far infrared matches the frequency of the water in the cell.

Conventionally, gypsum boards used as the building components such as ceiling boards and wall panels are merely decorative elements in the interior of a building and do not serve to promote healthy living environment.

US Patent 2002/0011046 A1 discloses an invention pertaining to a construction material for interior finishing of rooms that can generates far-infrared radiation and negative ions through the coating and adhesive used in the said construction material. However, coatings and adhesives are susceptible to peeling or detachment from the plates and thus reducing the ability to generate negative ions and far-infrared radiation over time.

In an invention disclosed in US Patent 2006/0157676 A1, a surface covering material has a negative ion producing material in it and the density of the ions is about 100 ions/cc to 6(50) ions/cc. The density of negative ions emitted is relatively low due to the fact of the ion producing material is positioned not greater than one milimeter from the surface in contact with air.

Another invention disclosed in U.S. Pat. No. 7,359,176 consisting of a board that is capable of generating negative ions through the discharge electrodes and induction electrodes embedded in the board. In this invention, AC voltage is applied to the electrodes to generate negative ions.

The present invention seeks to address the above mentioned technical disadvantages and to improve the efficiency in generating negative ions and far-infrared radiation from any existing arts.

### SUMMARY OF THE PRESENT INVENTION

It is an object of the present invention to provide a gypsum board for generating negative ions and far-infrared radiation that can offer a healthier living environment. The method of producing the gypsum board involves incorporating a pulverized mineral powder capable of emitting negative ions and far-infrared radiation into a mixture of board materials as the surface layer of the said board. A layer of fiber glass is sandwiched between the surface layer and a base to provide strength to the gypsum board while a base adhered to the layer of fiber glass forms a protective base for the gypsum board.

It would be advantageous to provide a gypsum board offering a healthier living environment through the beneficial effects of emitted negative ions and far-infrared radiation, in addition to an aesthetic function.

It would be advantageous to provide a gypsum board incorporating pulverized mineral powder that responsible for negative ions and far-infrared radiation emission into the surface layer of the gypsum board to ensure the optimal emission of negative ions and far-infrared radiation.

It would be advantageous to provide a gypsum board offering a healthier living environment that has sufficient strength for use in construction building materials.

It would be advantageous to provide a gypsum board that generates negative ions and far-infrared radiation without using electrical supply.

It is therefore an objective of the invention to provide means for generating negative ions to purify and clean the air by removing airborne contaminants.

It is a further objective of the invention to provide means for generating negative ions to remove unpleasant odor from enclosed living space.

It is yet another objective of the invention to provide a gypsum board means for continuous generation of negative ions and far-infrared radiation to promote healthy living environment.

### BRIEF DESCRIPTION OF DRAWINGS

A complete understanding of the present invention may be obtained by reference to the accompanying drawings, when considered in conjunction with the subsequent, detailed description, in which:

FIG. 1 is a perspective view of the gypsum board means for generating negative ions and far-infrared radiation in accordance with the invention; and

FIG. 2 is an exploded view of the gypsum board means for generating negative ions and far-infrared radiation in accordance with the invention.

For purpose of clarity and brevity, like elements and components will bear the same designations and numbering throughout the Figures.

### DESCRIPTION OF THE PREFERRED EMBODIMENT

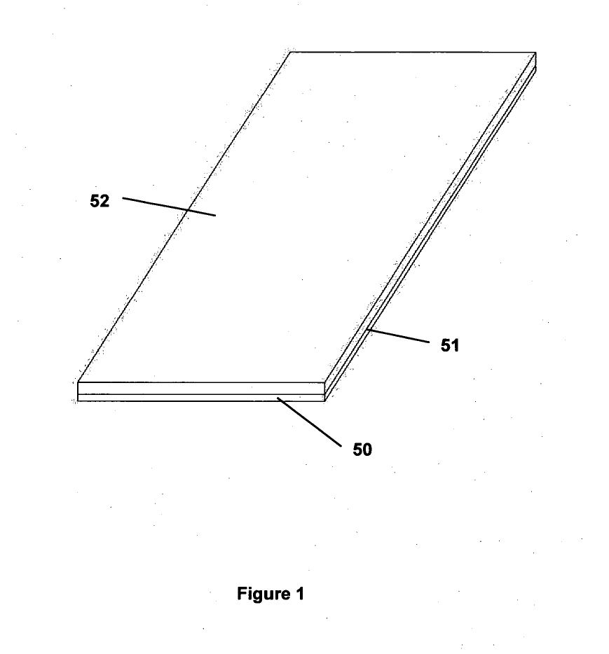

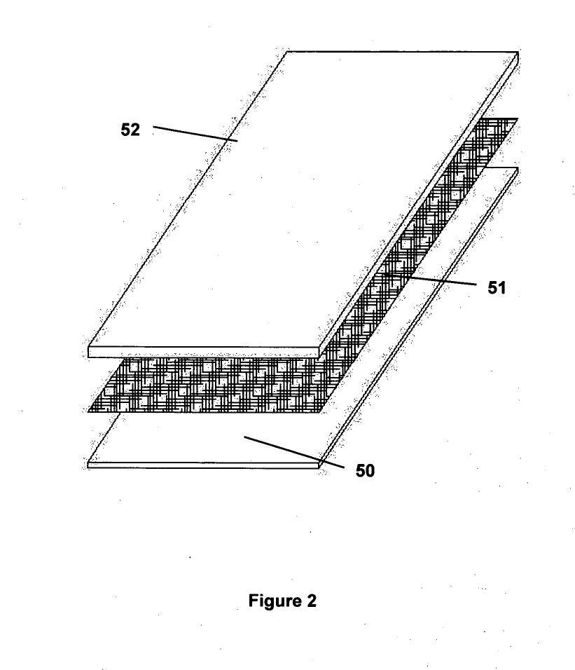

An embodiment of the invention is to be described with reference to the FIGS. 1 and 2.

This invention is concerning a gypsum board means for generating negative ions and far-infrared radiation, in which the gypsum board is preferably ceiling board and/or wall partition used for building interior.

The gypsum board means for generating negative ions and far-infrared radiation comprises of plurality of layers, preferably three layers. The surface panel (50) comprises of pulverized mineral powder, gypsum powder and water. The pulverized mineral powder consists of various minerals capable of generating negative ions and far infrared radiation. The composition of the pulverized mineral powder is as shown in Table 1.

TABLE 1

| Parameter | Weight Percentage (%) |
|---|---|
| Silicon Oxide as SiO₂ | 39.46 |
| Phosphorus Oxide as P₂O₅ | 19.51 |
| Aluminium Oxide as Al₂O₃ | 15.97 |
| Zirconium Oxide as ZrO₂ | 8.67 |
| Iron Oxide as Fe₂O₃ | 2.77 |
| Thorium Oxide as ThO₂ | 2.51 |
| Titanium Oxide As TiO₂ | 2.22 |
| Calcium Oxide as CaO | 1.84 |
| Potassium Oxide as k₂O | 1.61 |
| Gadolinium Oxide as Gd₂O₃ | 1.19 |
| Magnesium Oxide as MgO | 0.94 |
| Yttrium Oxide as Y₂O₃ | 0.71 |
| Sulphur Oxide as SO₃ | 0.30 |
| Sodium Oxide as Na₂O | 0.26 |
| Barium Oxide as BaO | 0.19 |
| Chlorine as Cl | 0.10 |
| Uranium Oxide as U₃O₈ | 0.09 |
| Zinc Oxidee as ZnO | 0.09 |
| Manganese Oxide as MnO | 0.07 |
| Dysprosium Oxide as Dy₂O₃ | 0.06 |
| Thulium Oxide as Tm₂O₃ | 0.04 |
| Tungsten Oxide as WO₃ | 0.02 |
| Nickel Oxide as NiO | 0.02 |
| Luterium Oxide as Lu₂O₃ | 0.02 |
| Strontium Oxide as SrO | 0.01 |
| Hafnium Oxide as HfO₂ | <0.01 |
| Other minerals | 1.33 |

The minerals stated in Table 1 are ionic minerals that release negative ions and far infrared radiation continuously. Such continuous emission occurs without any application of heat, pressure, chemical aid or power supply to activate the ionization process.

The surface panel (50) serves as the surface layer of the gypsum board exposing to the interior of a building with the intention of maximizing the area to emit negative ions and far-infrared radiation. There is no barrier that blocks the negative ions emitted as compared to the prior art. The density of negative ions emitted from the gypsum board is inspected to be at least 100000 negative ions/cc (per cubic centimeter). The existence of negative ions and far-infrared radiation is known to purify air by removing airborne particles and contaminants and to eliminate irritating odors from a living space. Hence, a healthier living environment is provided through the beneficial effects of negative ions and far-infrared radiation. The layer of fiber glass (51) is sandwiched between the surface panel (50) and a base (52) means for reinforcing the gypsum board whereby the layer of fiber glass (52) is formed from evenly distributed fiber glass strands. The base (52) is attached to the layer of fiber glass (51) and it comprises of mixture of gypsum powder and water means. for covering the layer of fiber glass (51) and serves as a protective base for the gypsum board.

The dimension of the gypsum board for generating negative ions and far-infrared radiation can be of any reasonable dimensions, preferably with the approximated dimension of 0.910 m×1.830 m×0.009 m. The thickness of the surface panel (50) is approximately 2 mm and for the layer of fiber glass (51) is about 1 mm while the base thickness is approximately 6 mm.

The present invention also disclosed a method of producing the gypsum board for generating negative ions and far-infrared radiation. The first step is to prepare a ionic mixture with about 0.09 wt % to 0.15 wt % of pulverized mineral powder, about 10.0 wt % to 15.0 wt % of gypsum powder and about 9.0 wt % to 12.0 wt % of water. A gypsum mixture with approximately 70 wt % to 80 wt % of gypsum powder and water is prepared simultaneously. The second step is to mold the ionic mixture in a precast mold to form the surface panel (50) and followed by leveling of the surface panel (50) using a leveling means. Next, approximately 2 wt % to 3 wt % of fiber glass is distributed evenly onto the surface panel (50) to form the layer of fiber glass (51). The layer of fiber glass (51) is leveled using a cylindrical roller means to ensure an even surface. Subsequently, the gypsum mixture is added onto the layer of fiber glass (51) to form the base (52) and followed by leveling of the base (52) using a leveling means. Then the gypsum board is settled and removed from the precast mold. Finally, the gypsum board is cured for approximately 5 days at room temperature, preferably 25° C. to 28° C. under the exposure of sun. The steps to form the layer of fiber glass (51) and the base (52) are executed instantaneously after the molding of the surface panel (50) to avoid the surface panel (50) to lose its moisture and harden before the layer of fiber glass (51) and the base (52) are added onto the surface panel (50). The hardening of surface panel (50) before the addition of layer of fiber glass (51) and the base (52) can leads to insecure adherent between the three layers.

The final total weight of the gypsum board means for generating negative ions and far-infrared radiation is approximately 64 wt % of the initial total weight of the gypsum board whereby about 36 wt % of water has evaporated after the curing process.

We claim:

1. A gypsum board for generating negative ions and far-infrared radiation, comprising:
a surface panel (50) embedded with pulverized mineral powder means for generating negative ions and far-infrared radiation;
a base (52) means for covering; and
a layer of fiber glass (51) sandwiched in between the surface panel (50) and the base (52) means for providing strength reinforcement to the gypsum board.

2. The gypsum board for generating negative ions and far-infrared radiation in accordance with claim 1, wherein the gypsum board is used as building material, preferably ceiling board and wall partition.

3. The gypsum board for generating negative ions and far-infrared radiation in accordance with claim 1, wherein the surface panel (50) comprises of pulverized mineral powder in a range of 0.09 wt % to 0.15 wt % of the initial total weight of the gypsum board, gypsum powder in a range of 10.0 wt % to 15.0 wt % of the initial total weight of the gypsum board and water in a range of 9.0 wt % to 12.0 wt % of the initial total weight of the gypsum board.

4. The surface panel (50) in accordance with claim 3, wherein the pulverized mineral powder comprises of ionic minerals means for generating negative ions and far-infrared radiation.

5. The gypsum board for generating negative ions and far-infrared radiation in accordance with claim 1, wherein the layer of fiber glass (51) comprises of fiber glass in a range of 2.0 wt % to 3.0 wt % of the initial total weight of the gypsum board.

6. The gypsum board for generating negative ions and far-infrared radiation in accordance with claim 1, wherein the base (52) comprises of mixture of gypsum powder and water in a range of 70 wt % to 80 wt % of the initial total weight of the gypsum board.

7. The gypsum board for generating negative ions and far-infrared radiation in accordance with claim 1, wherein the dimension of the gypsum board can be of any dimension, preferably with the approximated dimension of 0.910 m×1.830 m×0.009 m.

8. The gypsum board for generating negative ions and far-infrared radiation in accordance with claim 1, wherein the density of negative ions emitted is at least 100000 ions/cc.

9. A method for producing the gypsum board for generating negative ions and far-infrared radiation comprising the steps of:
First, mixing the pulverized mineral powder with gypsum powder and water to form an ionic mixture;
Simultaneously, mixing gypsum powder with water to form a gypsum mixture;
Second, molding the ionic mixture using a precast mold to form the surface panel (50);
Third, means for leveling the surface panel (50);
Fourth, means for distributing the fiber glass on the surface panel (50) to form the layer of fiber glass (51);
Fifth, means for leveling the layer of fiber glass (51) using a cylindrical roller means;
Sixth, adding the gypsum mixture onto the layer of fiber glass (51) to form the base (52);
Seventh, means for leveling the base (52);
Eighth, means for settling the gypsum board;
Ninth, removing the gypsum board from the mold; and
Means for curing of the gypsum board;

10. The method for producing the gypsum board for generating negative ions and far-infrared radiation in accordance with claim 10, wherein the means for curing of the gypsum board requires approximately 5 days at room temperature, preferably 25° C. to 28° C.

11. The gypsum board for generating negative ions and far-infrared radiation in accordance with claim 1, wherein the final total weight of the gypsum board after curing is approximately 64% of the initial total weight of the gypsum board.
